(19) United States
(12) Patent Application Publication
(10) Pub. No.: US 2009/0100689 A1
(43) Pub. Date: Apr. 23, 2009

(54) Chain saw

(76) Inventor: Kouichi Shimokawa, Saitama (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/920,455

(22) PCT Filed: Dec. 26, 2006
(86) PCT No.: PCT/JP2006/325915

§ 371 Date: Nov. 15, 2007

(30) Foreign Application Priority Data
Dec. 28, 2005 (JP) 2005-380226

(51) Int. Cl. B27B 17/00

(52) U.S. Cl. 30/381

(57) ABSTRACT

An oil tank (431) for storing oil for lubricating a saw chain (21) and a fuel tank (443) for storing fuel for an engine (5) are integrally formed with a top handle (41) provided on an upper side of a body (3). The body (3) and the top handle (41) are connected by a connecting spring such that vibration transmission from the body (3) to the top handle (41) is restrained. In other words, since the heavy oil tank (431) and the weighty fuel tank (443) are integrally formed with the top handle (41) to trim the weight of the body (3) that generates vibration, vibration transmitted to the top handle (41) is decreased to improve the vibration insulation of a chain saw (1).

### TECHNICAL FIELD

The present invention relates to a chain saw.

### BACKGROUND ART

Conventionally, a chain saw has been known as a cutting instrument used for operations of logging and pruning.

A conventional chain saw includes a tabular guide bar, a body that supports the guide bar and houses an engine for driving a saw chain wound around the guide bar and a handle connected to the body to be grasped by operators. The body houses an oil tank, a fuel tank, a muffler and the like as well as the engine. Among such chain saws, there is a top-handle type chain saw where the handle is provided on the upper side of the body (for example, Patent Documents 1, 2, 3).

[Patent Document 1] JP-B-3-58281

[Patent Document 2] JP-UM-A-2-34725 (Japanese Utility Model Registration Application No. 63-113160)

[Patent Document 3] JP-A-9-151739

### DISCLOSURE OF THE INVENTION

### Problems to be Solved by the Invention

Since such a chain saw is difficult to be handled when vibration generated upon logging operations and the like is so big that it is transferred to operators via the handle, improvement of vibration insulation has been required.

An object of the present invention is to provide a chain saw that is improved in vibration insulation.

### Means for Solving the Problems

According to an aspect of the present invention, a chain saw includes a body to house an engine for driving a saw chain in a horizontal orientation and a top handle provided on an upper side of the body, in which an oil tank for storing oil for lubricating the saw chain and a fuel tank for storing fuel for the engine are integrally formed with the top handle.

The oil tank and the fuel tank have been provided on the body that houses the engine according to conventional chain saws. However, according to the aspect of the present invention, since the heavy oil tank and the weighty fuel tank are integrally formed with the top handle to trim the weight of the body that generates vibration, vibration transmitted to the top handle is decreased to improve the vibration insulation of the chain saw.

In the chain saw according to the aspect of the present invention, the top handle may preferably include a grip to be grasped by operators, a first extension bent downward from a first side of the grip, a second extension to be bent downward from a second side of the grip and a bridge section bridged in between the first extension and the second extension.

In the above, since the bridge section is provided between the first extension and the second extension to improve the rigidity of the top handle, the operability and the vibration insulation of the chain saw can be further improved.

### BRIEF DESCRIPTION OF DRAWINGS

FIG. 1 is an entire perspective view showing a chain saw according to an embodiment of the present invention.

FIG. 2 is an exploded perspective view showing the chain saw according to the embodiment.

FIG. 3 is a cross-sectional view showing a body according to the embodiment.

FIG. 4 is a cross-sectional view showing the chain saw according to the embodiment.

FIG. 5 is a cross-sectional view showing the chain saw according to the embodiment.

FIG. 6 is a cross-sectional view showing a muffler according to the embodiment.

FIG. 7 is a cross-sectional perspective view showing a configuration inside the muffler according to the embodiment.

FIG. 8 is a cross-sectional view showing a top handle according to the embodiment.

FIG. 9 is an exploded perspective view showing a configuration around a carburetor according to the embodiment.

### EXPLANATION OF CODES

1: chain saw, 3: body, 5: engine, 21: saw chain, 41: top handle, 42: grip, 43: first extension, 44: second extension, 401: bridge section, 431: oil tank, 443: fuel tank

### BEST MODE FOR CARRYING OUT THE INVENTION

### Entire Configuration of Chain Saw

An embodiment of the present invention will be described below with reference to the accompanying drawings.

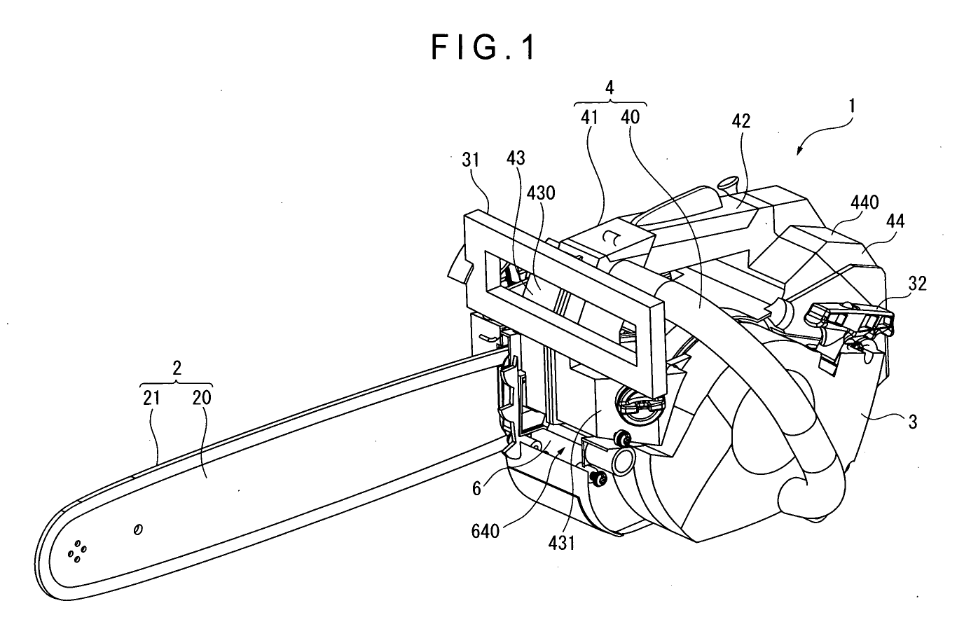

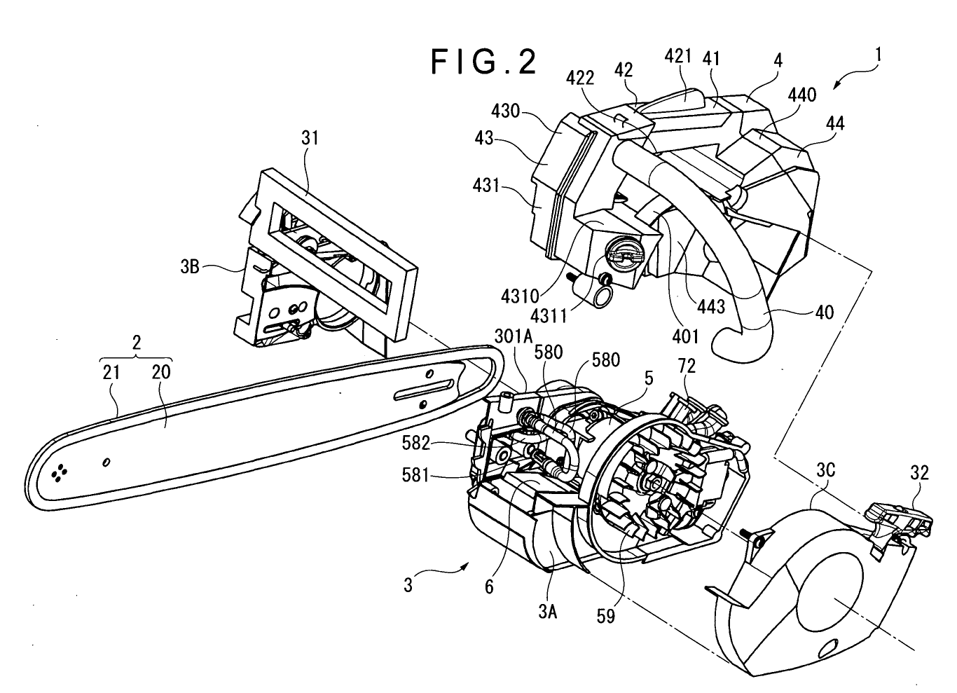

FIG. 1 is an entire perspective view showing a chain saw 1 according to the present embodiment. FIG. 2 is an exploded perspective view showing the chain saw 1.

The chain saw 1 includes a chain section 2, a body 3 and a handle 4 to support the body 3 as shown in FIG. 1.

The extending direction of a guide bar 20 is a front-rear direction in FIG. 1. The direction vertically perpendicular to the front-rear direction is an up-down direction. The direction horizontally perpendicular to the front-rear direction is a left-right direction.

The chain section 2 includes the tabular guide bar 20 and a saw chain 21 wound around the guide bar 20 as shown in FIG. 2.

The body 3 is covered with a body case 3A, a case cover 3B attached to the right side of the body case 3A so as to interpose the guide bar 20 and a case cover 3C attached to the left of the body case 3A. An engine 5 for driving the saw chain 21 is provided inside the body case 3A. A hand guard 31 is provided on the upper side of the front side of the case cover 3B. A recoil starter handle 32 is provided on the case cover 3C. The handle 4 includes a side handle 40 and a top handle 41 provided on the upper side of the body 3.

### [Configuration of Engine]

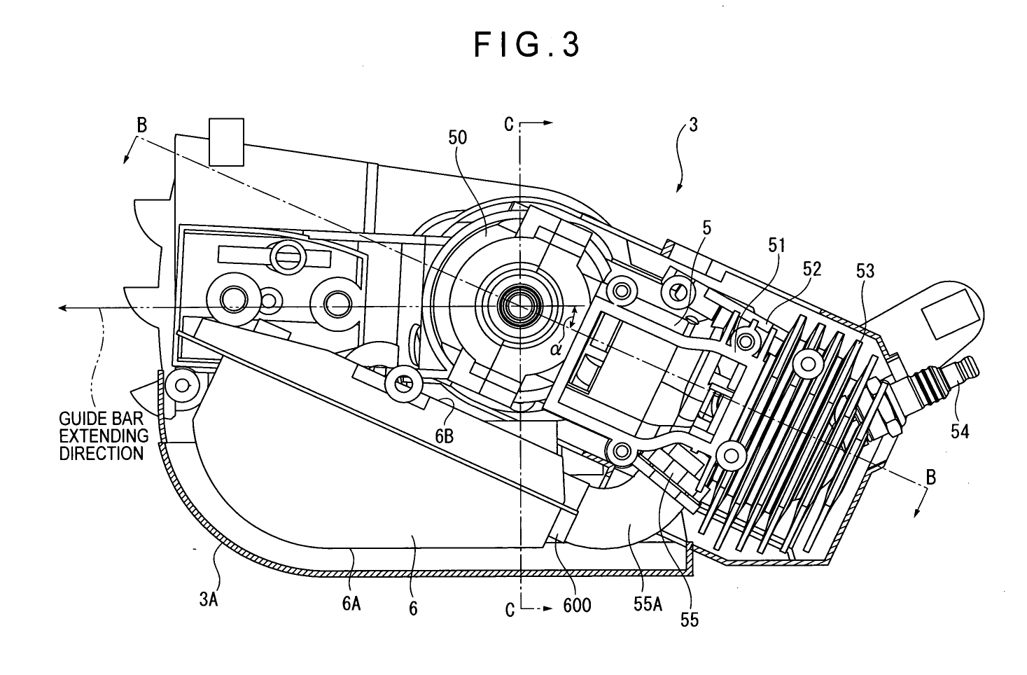

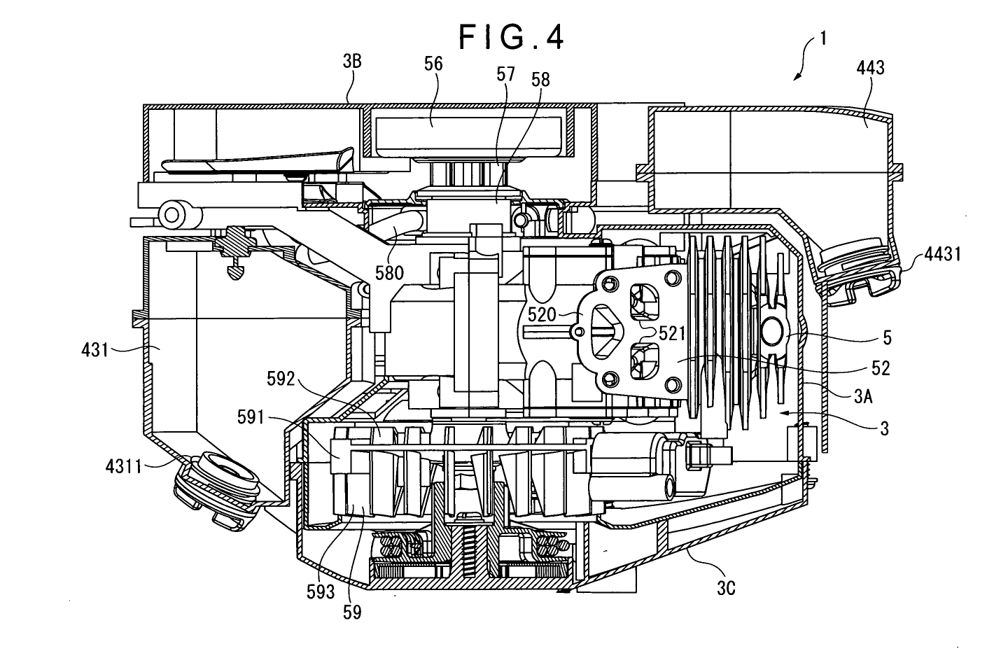

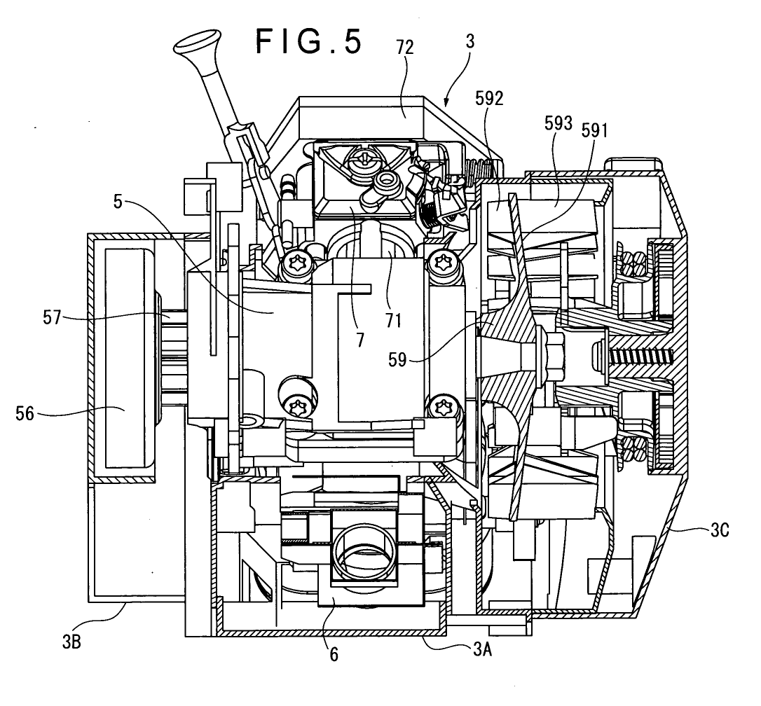

FIG. 3 is a cross-sectional view showing the body 3. FIG. 4 is a cross-sectional view taken along B-B line in FIG. 3. FIG. 5 is a cross-sectional view taken along C-C line in FIG. 3. It should be noted that the engine 5 is not shown in cross-section.

The engine 5 is a stratified scavenging two-stroke engine to suck air-fuel mixture from an air-fuel mixture port 520 opened at an insulator attachment 52 positioned above a cylinder 51 and scavenging air from an air port 521 opened at an insulator attachment 52 positioned above a cylinder 51. Then, the engine 5 discharges exhaust gas from an exhaust port 55 provided below the cylinder 51 at a position opposed to the air-fuel mixture port 520 and the air port 521. Specifically, the engine 5 is configured such that the sucking direction of the air-fuel mixture and the scavenging air and the discharging direction of the exhaust gas are approximately vertically aligned. Further, a piston-valve method where the air-fuel mixture port 520 is opened and closed with a lateral portion of a piston is applied to suck air-fuel mixture.

The engine 5 is housed inside the body case 3A in a posture where the cylinder is in a horizontal orientation. Specifically, the engine 5 is in a position where the portion from a crankcase 50 provided to the substantial center of the body case 3A toward the cylinder 51 is slightly laid back downwards. In the present embodiment, the inclination angle α of the axis line of the cylinder 51 with respect to the extending direction of the guide bar 20 is approximately twenty-five degrees. Further, an end of a cylinder head 53 on the top dead center thereof is provided with a plug 54 that protrudes upward from the rear of the body case 3A.

The exhaust port 55 arranged on the engine 5 is attached to an exhaust pipe 55A that sends exhaust gas to a muffler 6 provided below the engine 5. The exhaust pipe 55A is formed to be curved to smoothly send exhaust gas discharged from the engine 5 to the muffler 6 such that the exhaust efficiency of the engine 5 can be improved.

A centrifugal clutch 56, a sprocket 57 that rotates the saw chain 21 via the centrifugal clutch 56 and an oil pump 58 that is on the inner side of the sprocket 57 are attached on the right end of the crankshaft (the upper side of FIG. 4) as shown in FIG. 4.

A fan 59 for cooling the engine 5 is attached on the left end of the crankshaft (the right side of FIG. 5) as shown in FIG. 5.

### [Configuration of Fan]

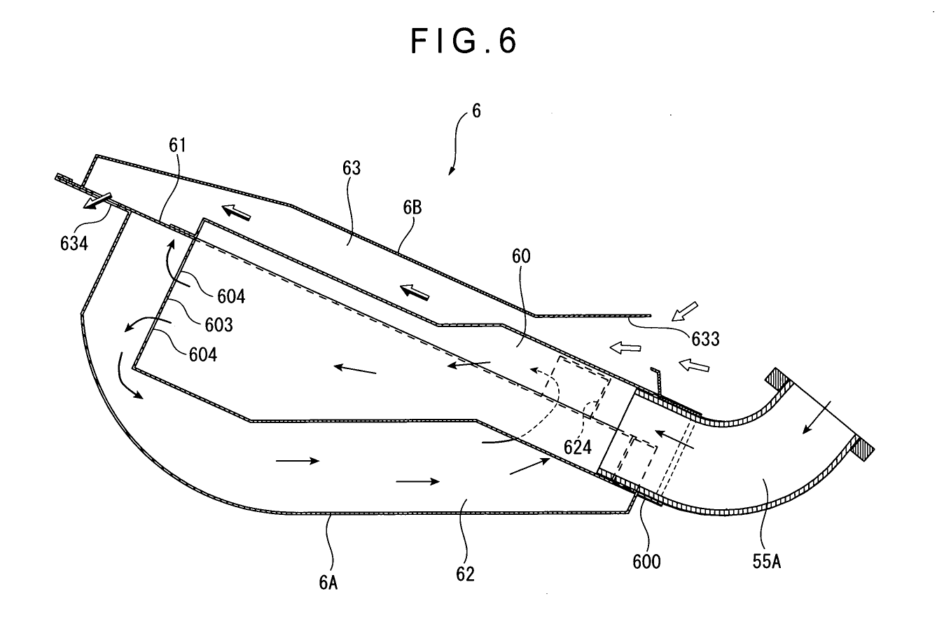

The fan 59 includes an inner blade 592 provided on the inner side of a disk-shaped flange 591 and an outer blade 593 provided on the outside of the flange 591. The inner blade 592 provided on the inner side of the flange 591 sucks air mainly from a slit (not shown) formed below the body case 3A and sends cooling air to the engine 5 and the like. The outer blade 593 provided on the outward side of the flange 591 sucks air mainly from a slit (not shown) formed on the case cover 3C and sends cooling air. Since the inner blade 592 is provided on the inner side of the fan 59 as above, more cooling air can be sent to improve the cooling efficiency of the engine 5. The cooling air generated by the fan 59 is also sent to an air intake 633 on the side of the muffler 6 of FIG. 6 through below the cylinder 51.

### [Configuration of Muffler]

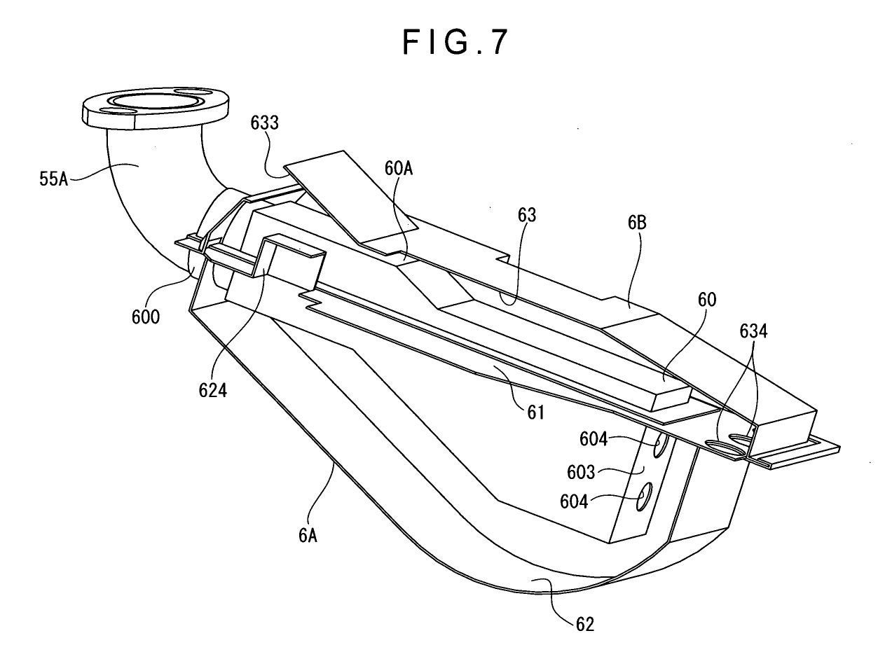

FIG. 6 is a cross-sectional view showing the muffler 6. FIG. 7 is a cross-sectional perspective view showing a configuration inside the muffler 6.

The muffler 6 is housed in an interior space of the body case 3A formed from the downside of the engine 5 toward the front side of the engine 5 and formed in a box that includes a bottom 6A extending along with the inner surface of the body case 3A and an upper surface 6B inclined at the substantially same angle as the inclination angle α of the cylinder 51. Further, a first damping chamber 60 in communication with the exhaust pipe 55A is provided inside the muffler 6 as shown in FIGS. 6 and 7. A partition 61 is inserted in an upper side of the first damping chamber 60. The partition 61 is inclined upward toward the front at the substantially same angle as the inclination angle α of the cylinder 51. A second damping chamber 62 that is a space below the partition 61 and a third damping chamber 63 that is a space above the partition 61 are formed outside the first damping chamber 60.

The first damping chamber 60 is formed elongated toward the front and provided with a first outlet 604 on each of the upper portion and the lower portion of a front surface 603, which allows the first damping chamber 60 to be in communication with the second damping chamber 62. A second outlet 624 that allows the second damping chamber 62 to be in communication with the third damping chamber 63 is provided on the rear right side of the partition 61. Further, an air intake 633 protruded upward and opened backward is provided on the upper surface 6B of the third damping chamber 63. Cooling air sent by the fan 59 flows into the air intake 633. Further, an exhaust port 634 is provided on the bottom surface of the front end of the third damping chamber 63 at a portion protruded from the second damping chamber 62. The exhaust port 634 is in communication with an exhaust opening 640 formed in between the lower surface of an oil tank 431 and the upper surface of the muffler 6 as shown in FIG. 1.

According to the above configuration, exhaust gas sent from the exhaust pipe 55A first flows forward through the first damping chamber 60 and enters into the second damping chamber 62 via the first outlet 604. Then, the exhaust gas hits the front surface of the second damping chamber 62 and turns around backward along the bottom 6A to enter into the third damping chamber 63 via the second outlet 624. Finally, exhaust gas mixes with cooling air flowed from the air intake 633 and comes out of the exhaust port 634 to be discharged outside through the exhaust opening 640.

Since the air intake 633 is provided on the upper surface 6B of the third damping chamber 63 such that cooling air sent from the fan 59 flows in and mixes with exhaust gas, exhaust gas can be cooled down. Further, since the muffler 6 is provided below the engine 5 and the exhaust port 634 is provided on the front end of the muffler 6, exhaust gas can be discharged toward the front of the body 3 and exhaust sound from the muffler 6 can also be transmitted toward the front so that the sound is less likely to be heard by operators.

### [Entire Configuration of Handle]

One end of the side handle 40 of the handle 4 is connected to the top handle 41 and the other end is connected to the lower portion of the case cover 3C by a connecting spring (not shown) as shown in FIGS. 1 and 2. As mentioned above, since the handle 4 includes the side handle 40 bridged between the top handle 41 and the lower portion of the case cover 3C, operators can grasp the top handle 41 with one hand and the side handle 40 with the other hand to securely operate the chain saw 1 to improve the operability of the chain saw 1. Incidentally, the handle 4 is connected to the body 3 by connecting springs (not shown) at least at three or more positions including the connecting position of the other end of the side handle 40 and the case cover 3C.

The top handle 41 includes a grip 42 to be grasped by operators, a first extension 43 to be extended to be bent downward from the front of the grip 42, a second extension 44 to be extended to be bent downward from the rear of the grip 42 and a bridge section 401 bridged in between the first extension 43 and the second extension 44 as shown in FIG. 2.

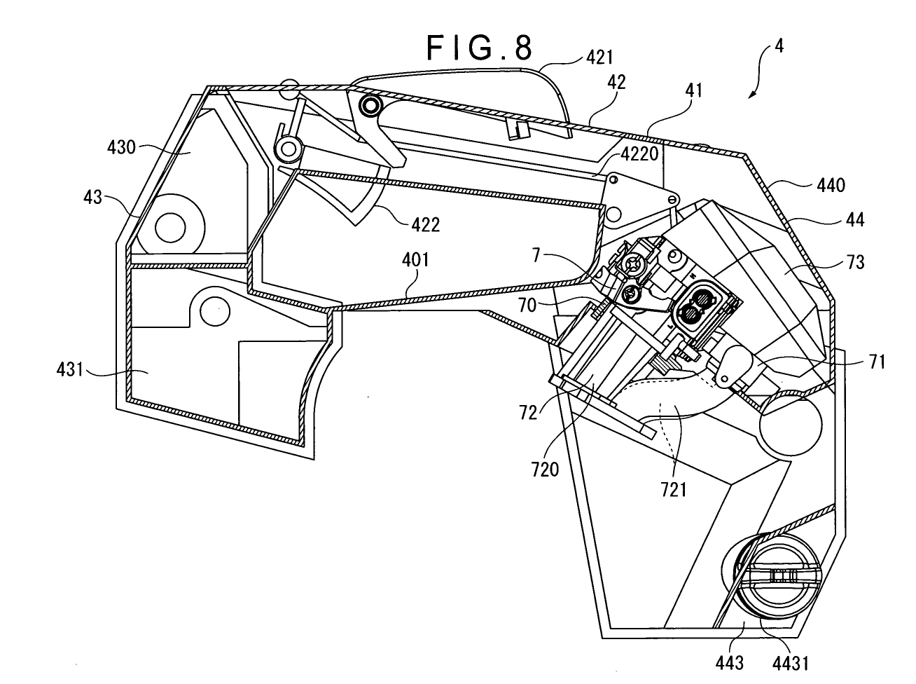

FIG. 8 is a cross-sectional view showing the top handle 41.

The grip 42 is provided with a throttle lever 422 for adjusting the output of the engine 5 and a stopper 421 for regulating the movement of the throttle lever 422 as shown in FIGS. 2 and 8.

The first extension 43 is provided with a hollow support 430 and the oil tank 431 integrally formed on the lower end of the support 430 and is placed above the muffler 6. One end of the side handle 40 is attached to the support 430. The oil tank 431 includes an expanded portion 4310 extended toward the left. An oil supply 4311 for storing oil for lubricating the saw chain 21 is provided on a tip end of the expanded portion 4310. Oil is delivered through an oil tube 580 and an oil tube 582 to the outside of a guide bar attachment 301A integrally formed with the crankcase 50 by the above-mentioned oil pump 58 to lubricate the saw chain 21 as shown in FIG. 2. Further, one end of the bridge section 401 is bonded to a portion of the expanded portion 4310 extended rearwards.

The second extension 44 is provided with a handle case 440 and a fuel tank 443 and is placed above the rear of the engine 5.

The handle case 440 is a continuation of the grip 42, inside which a carburetor 7 is provided. A configuration around the carburetor 7 is abbreviated here as it will be described later. Incidentally, the other end of the bridge section 401 is bonded to the lower portion of the handle case 440. The fuel tank 443 is integrally formed from the right side of the second extension 44 toward the lower side of the second extension 44. Further, a fuel supply 4431 is provided on the lower portion of the fuel tank 443. Fuel is delivered to the carburetor 7 through a fuel tube (not shown).

As described above, the body 3 and the top handle 41 are connected by the connecting spring such that vibration transmission from the body to the top handle 41 is restrained according to the present embodiment. Further, since the heavy oil tank 431 and the weighty fuel tank 443 are integrally formed with the top handle 41 to trim the weight of the body 3 that generates vibration, vibration transmitted to the top handle 41 is decreased to improve the vibration insulation of the chain saw 1. Additionally, since the heavy oil tank 431 and the weighty fuel tank 443 are integrally formed respectively with the first extension 43 provided at the front side of the grip 42 and the second extension 44 provided at the rear side of the grip 42, the weight can be well balanced and the operability can be further improved.

Further, since the bridge section 401 is provided between the first extension 43 and the second extension 44 to improve the rigidity of the top handle 41, the operability and the vibration insulation of the chain saw 1 can be further improved.

### [Configuration Around Carburetor]

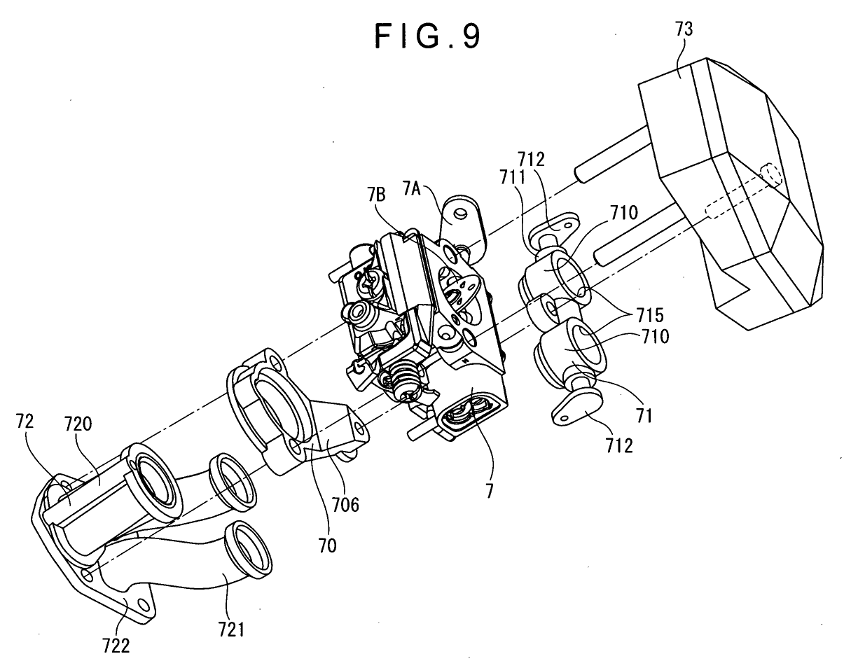

FIG. 9 is an exploded perspective view showing a configuration around the carburetor 7.

An air regulator 71 is attached behind the carburetor 7 (the lower side of the backward slant of FIG. 8) via a joint 70 that is on the side of the engine 5 as shown in FIG. 9. An air valve (not shown) is provided inside an air path 715 of the air regulator 71. The air valve is opened and closed by an air valve calibrator 712 provided on the lateral side of the air regulator 71. The air valve calibrator 712 is connected to a throttle valve calibrator 7A provided on the carburetor 7 via a connector such as a wire and the like. The throttle valve calibrator 7A provided on the carburetor 7 is connected to the throttle lever 422 via a wire 4220 (FIG. 8) to open and close a throttle valve 7B.

Further, an air cleaner 73 is attached above the carburetor 7 and the air valve. An insulator 72 is attached below the carburetor 7 and the air valve. The insulator 72 is provided with an air-fuel mixture path 720 mounted on an iron plate 722 and an air path 721 mounted on the iron plate 722 to be placed behind the air-fuel mixture path 720 (the lower side of the backward slant of FIG. 8) and connected to an insulator attachment 52 of the engine 5 (FIG. 4) upon assembly. Consequently, the air-fuel mixture path 720 allows the carburetor 7 to be in communication with an air-fuel mixture port 520 to send air-fuel mixture to the engine 5. The air path 721 allows the air regulator 71 to be in communication with the air port 521 to send scavenging air to the engine 5.

Thus, when the throttle lever 422 is moved, the throttle valve calibrator 7A connected to the throttle lever 422 via the wire 4220 can be accordingly moved to open and close the throttle valve 7B to adjust the amount of air-fuel mixture sent to the engine 5. Furthermore, when the throttle lever 422 is moved, the air valve calibrator 712 connected to the throttle valve calibrator 7A can also be accordingly moved to open and close the air valve to adjust the amount of scavenging air sent to the engine 5 to control the output of the engine 5.

Additionally, the air-fuel mixture path 720 and the air path 721 of the insulator 72 are made from an elastic material with thermal insulating properties to absorb vibration and suppress heat transfer from the engine 5 to the carburetor 7.

Specifically, in the same manner as absorbing the vibration transmission to the handle 4 by the connecting spring made of elastic material, the vibration caused on the body 3 is absorbed by the air-fuel mixture path 720 and the air path 721 made of an elastic material, so that vibration to the carburetor 7 that leads to vibration to the handle 4 via the carburetor 7 can be suppressed.

The scope of the present invention is not limited to the above embodiment but includes following modifications as long as an object of the present invention can be achieved.

Although the carburetor 7 is housed in the top handle 41 according to the above-mentioned embodiment, the carburetor 7 may be housed in the body case 3A. The fuel tank 443 may then be provided to the space where the carburetor 7 is housed. Since the fuel tank 443 is also integrally formed with the top handle 41 even in this case, the same advantage as the above-mentioned embodiment can be enjoyed by the same configuration as the above-mentioned embodiment.

Further, according to the above-mentioned embodiment, air-fuel mixture is sucked by a piston-valve method that provides the air-fuel mixture port 520 on the cylinder 51 to control air-fuel mixture intake with a lateral portion of a piston. However, air-fuel mixture may be sucked by a lead-valve method that provides the air-fuel mixture port 520 on the crankcase 50 to control air-fuel mixture intake with a lead-valve. Additionally, a stratified scavenging two-stroke engine may not be applied.

Further, although the inclination angle α of the axis line of the cylinder 51 with respect to the extending direction of the guide bar 20 is approximately twenty-five degrees according to the above-mentioned embodiment, the inclination angle α may be any degrees as long as the engine 5 is in a position where the portion from the crankcase 50 toward the cylinder 51 is slightly laid back downwards, in other words, housed inside the body 3 in a position where the cylinder is in a horizontal orientation.

Although the connecting spring is used as a connector to connect the handle 4 and the body 3, any elastic component may be used as long as the handle 4 and the body 3 can be firmly connected and supported.

### INDUSTRIAL APPLICABILITY

The present invention can preferably be applied to a small chain saw.

1. A chain saw, comprising: a body to house an engine for driving a saw chain in a horizontal orientation; and
a top handle provided on an upper side of the body,
wherein an oil tank that stores oil to lubricate the saw chain and a fuel tank that stores fuel for the engine are integrally formed with the top handle.

2. The chain saw according to claim 1,
wherein the top handle includes a grip to be grasped by operators, a first extension bent downward from a first side of the grip, a second extension bent downward from a second side of the grip and a bridge section bridged in between the first extension and the second extension.
